(19) United States
(12) Patent Application Publication
(10) Pub. No.: US 2012/0002504 A1
(43) Pub. Date: Jan. 5, 2012

(54) GRAVITY MEASUREMENTS IN MARINE, LAND AND/OR SEABED SEISMIC APPLICATIONS

(76) Inventors: Everhard MUYZERT, Girton (GB); Philip A.F. Christie, Fen Drayton (GB); Nicolas Goujon, Oslo (NO); Julian Edward (ED) Kragh, Finchingfield (GB); Johan O.A. Robertsson, Grantchester (GB)

(21) Appl. No.: 13/207,488

(22) Filed: Aug. 11, 2011

Related U.S. Application Data
(63) Continuation-in-part of application No. 12/938,866, filed on Nov. 3, 2010.
(60) Provisional application No. 61/494,146, filed on Jun. 7, 2011.
(60) Provisional application No. 61/499,232, filed on Jun. 21, 2011.
(60) Provisional application No. 61/309,254, filed on Mar. 1, 2010.

(51) Int. Cl. G01V 1/38

(52) U.S. Cl. 367/21

(57) ABSTRACT

A technique facilitates collection and use of data on subterranean formations. The technique comprises creating a distributed sensor network having multiple sensors arranged in a desired pattern. The distributed sensor network is employed to collect seismic data from the multiple sensors. Additionally, the distributed network and sensors are designed to collect gravity data from the multiple sensors. The sensors may be arranged in a variety of environments, including land-based environments and seabed environments.

### CROSS-REFERENCE TO RELATED APPLICATION

The present document is based on and claims priority to U.S. Provisional Application Ser. No.: 61/494,146, filed Jun. 7, 2011, and to U.S. Provisional Application Ser. No.: 61/499,232, filed Jun. 21, 2011; and is a Continuation-in-Part of U.S. patent application Ser. No. 12/938,866, filed Nov. 3, 2010, which, in turn, is based on and claims priority to U.S. Provisional Application Ser. No.: 61/309,254, filed Mar. 1, 2010.

### BACKGROUND

Seismic surveys are performed in a variety of environments to gain a better understanding of the geometry and seismic wavespeeds of subterranean geological formations and structures. Gravity measurements also are made to provide complementary knowledge with respect to the distribution of mass in subterranean regions. Examples of gravity measurements include ship borne dynamic gravity measurements which may be made using, for example, an upgraded LaCoste & Romberg gravity meter. Ship borne gravimeters are normally mounted on gyro-stabilized platforms to minimize pitch and roll, and gravity signal outputs are heavily filtered to remove accelerations due to waves. In current practice, accurate vessel speed and direction measurements may be obtained from GPS and used to correct for gravimeter motion leading to the Eötvös correction for Coriolis acceleration, proportional to the eastward velocity component of the gravimeter. Large amplitude accelerations due to ocean waves have a dominant period of 5-10 s, and low-pass filtering below 3 minutes results in a residual ocean wave signal of less than 1 mGal. At periods longer than 1 minute, the Eötvös effect is the strongest perturbation but can be corrected accurately due to rapid sampling of navigation data at 1 s periods. Another ship borne gravity measurement method is Sea-Air Gravity Enhanced (SAGE) which is an enhanced marine inertial navigator system, WSN-7, based on a ring laser gyroscope. The ship borne systems use single gravity meters, although a vessel may operate two WSN-7 systems independently for redundancy. Current dynamic gravity measurements have a precision of about 0.2 mGal at a minimum half-wavelength of 0.5 km, where the spatial wavelength is determined by the filter applied to remove short period ocean wave accelerations and the speed of the vessel. Additionally, sensors have been constructed to measure seismic and gravity data simultaneously. However, dynamic ship borne gravimeters remain limited to the precision described above.

Gravity gradiometry is a technique in which gradients of a gravity field are measured. The gravity gradiometry technique was initiated to improve spatial sensitivity to more local variations in mass density, and gravity gradiometers have been used in locating boundaries between density contrasts in the earth such as those due to salt bodies. More recently, dedicated equipment has been developed which detects differences of acceleration between sensors mounted on the diameter of a rotating disc. Such a sensor arrangement, in principle, allows separation of linear accelerations of the platform from the gradio-gravimetry signal, greatly reducing the sensitivity to both platform accelerations and the Eötvös effect. However, such instruments are expensive and have required deployment on dedicated vessels.

### SUMMARY

In general, the present invention provides a methodology and a system for facilitating the collection and use of data on subterranean formations. The technique comprises creating a distributed sensor network having multiple sensors arranged in a desired pattern. The distributed sensor network is employed to collect seismic data from the multiple sensors. Additionally, the distributed network and sensors are designed to collect gravity data from the multiple sensors. The sensors may be arranged in a variety of environments, including land-based environments and seabed environments.

### BRIEF DESCRIPTION OF THE DRAWINGS

Certain embodiments of the invention will hereafter be described with reference to the accompanying drawings, wherein like reference numerals denote like elements, and:

FIG. 1 is a schematic view of a seismic system utilizing a distributed sensor network in which a seismic vessel pulls a plurality of seismic streamers having multiple sensors in a marine survey area, according to an embodiment of the present invention;

FIG. 2 is a schematic illustration of an example of a sensor comprising three orthogonal accelerometers, according to an embodiment of the present invention;

FIG. 3 is a schematic illustration of an alternate example of a sensor mounted on a gimbal system, according to an embodiment of the present invention;

FIG. 4 is a schematic view of an alternate seismic system utilizing a distributive sensor network having multiple sensors positioned along a solid surface, such as a land surface or a seabed, according to an alternate embodiment of the present invention;

FIG. 5 is a diagram illustrating one example for collecting, processing and providing data during a seismic survey, according to an embodiment of the present invention; and

FIG. 6 is a flowchart illustrating one example for calibrating gravity data obtained during the seismic survey, according to an embodiment of the present invention.

### DETAILED DESCRIPTION

In the following description, numerous details are set forth to provide an understanding of the present invention. However, it will be understood by those of ordinary skill in the art that the present invention may be practiced without these details and that numerous variations or modifications from the described embodiments may be possible.

The present invention generally relates to a technique for data acquisition during a seismic survey. The seismic survey may be conducted in a marine environment, e.g. along a sea surface or along a seabed, or along a land surface. According to one aspect of the technique, gravity data are obtained via multiple seismic sensors in a seismic distribution network. The gravity data may be related to, for example, measuring gravity and horizontal gravity gradients.

According to one embodiment, the seismic survey technique utilizes a distributed network of three-component sensors, e.g. three-component accelerometers. The distributed network may be employed in marine environments for marine seismic acquisition and ship borne gravity data acquisition. Alternatively, the distributed network may comprise permanently installed sensors which are utilized for both seismic and gravity measurements. In some applications, the distributed network of sensors may be employed in surface land environments or seabed environments. The gravity data from distributed measurements are processed along with the seismic data to enhance the seismic survey results and to provide complementary information on the relative distribution of mass density in the sub-surface.

In one embodiment, the sensors comprise three-component accelerometers each of which is mounted in the fixed reference frame of a desired distribution network, e.g. in the fixed reference frame of a marine streamer. In the marine streamer example, the streamer can have arbitrary orientation about its long axis and it may sag or float between depth birds according to its state of buoyancy. Because of this characteristic, the three-component accelerometer is designed to measure the DC acceleration due to gravity so as to resolve its orientation with respect to vertical, as defined by the local gravitational vector. This allows the seismic measurements to be rotated to a geographical reference frame.

Because the sensors are capable of measuring DC gravity, a distributed network of a large number of low-cost, relatively imprecise sensors can be employed to create a very accurate measurement of gravity at a spatial resolution which can distinguish sub-surface variations in the distribution of mass density. There may exist a trade-off between the precision of each sensor and the number of sensors needed to produce a useful estimate of gravity at a point. For example, a high-resolution marine gravimeter may represent one endpoint of the spectrum, while a seismic acquisition spread may represent the other endpoint. Sensor numbers, precision, cost, and capacity for dual use (e.g. gravity and seismic) are considerations in determining the suitability of a given distributed sensor network for acquiring useful gravity data.

Although use of sensors in marine streamers has been discussed above, the distribution networks having multiple sensors, e.g. accelerometers, also are readily used in land seismic acquisition systems or seabed seismic acquisition systems. The sensors also may be included in permanently installed distribution networks employed for monitoring in a variety of environments.

Recent advances in potential field data processing and inversion have shown how field functions, derived from distributed measurements of the gravity field and/or the spatial gradients of the gravity field, may be downward-continued in a stable manner to generate a high-resolution image of the causative body without the problem of continuing the measured field through the associated singularities. (See, for example, Zhdanov, M. S., 2002, Geophysical Inverse Theory and Regularization Problems, Elsevier; Zhdanov, M. S., Ellisz, R. & Mukherjee, S., 2004, Three-Dimensional Regularized Focusing Inversion of Gravity Gradient Tensor Component Data, Geophysics, 69, 925-937; and Zhdanov, M. S., Liu, X. & Wilson, G., 2010, Potential Field Migration for Rapid Interpretation of Gravity Gradiometry Data, EGM International Workshop, Capri, Italy, 11-14 Apr. 2010.) The description of potential field migration is analogous to seismic field migration and comprises a process which results, not in a direct solution in terms of the distribution of mass density, but in an image of the distribution of migration density. The resulting distribution of migration density enables computation of an appropriate spatial weighting operator from the sensitivity of the gravity fields or their gradients with respect to the density contrasts. A high density distributed gravity measurement in two surface dimensions is well-suited to such a processing/inversion scheme.

According to one embodiment, the technique employs a multi-component sensor survey system having, for example, multi-component accelerometers. In a marine/streamer environment, each streamer may include accelerometers with a frequency response down to 0 Hz, and continuous or almost continuous recording. In addition, the system may provide accurate streamer position, speed and direction information. Another aspect of the survey system is that each multi-component streamer has a large number of sensors, e.g. accelerometers. In some embodiments, the accelerometers are spaced less than a meter apart along each multi-component streamer. The streamers also may have substantial length with the individual multi-component streamers exceeding, for example, 6 km. Thus, an individual streamer may contain over 10,000 accelerometers. Furthermore, in some embodiments of the overall survey system, a tow vessel tows 10 streamers or more which provides well over 100,000 accelerometers simultaneously recording data. The large number of sensors also may be deployed in a land based or seabed based survey system.

By employing the multi-component seismic systems described herein, the system provides a technique for accurately measuring gravity and horizontal gradients of gravity. The multi-component seismic systems each include multiple accelerometers which may be used both for acquiring gravity data and for acquiring seismic measurements. The large number of sensors and the corresponding large number of measurements made by the sensors enhances the signal-to-noise ratio of the gravity estimates and facilitates accumulation of gravity measurements throughout a survey region. The large number of sensors and corresponding sensor measurements enables ensemble averaging of the large number of sensors to achieve a desired, improved precision as opposed to the spatial and temporal averaging of a single gravity sensor. In surface marine embodiments, the multi-component system may comprise streamers having sensors, and the large number of measurements may be made by the sensors during towing of the streamers. In alternate embodiments, the large number of sensors, e.g. accelerometers, can be employed in an alternate type of distribution network established in a surface land environment, along a seabed, or as a permanent installation in a variety of environments.

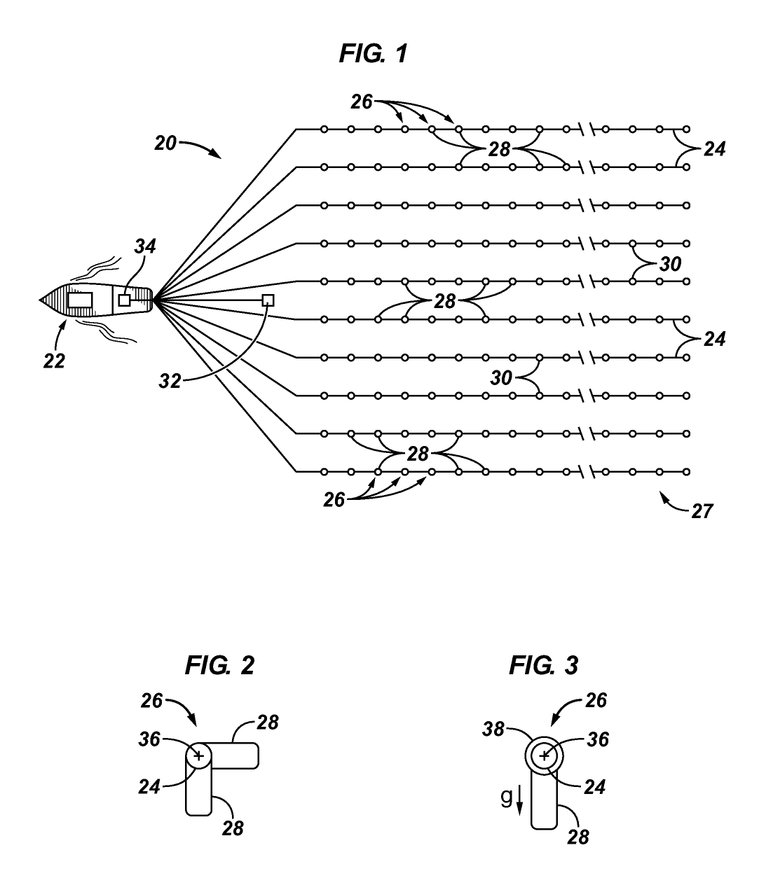

In a first example, illustrated generally in FIG. 1, a general survey system 20 is illustrated to show one example of a system and method for acquiring gravity data and/or seismic data on subterranean formations throughout a survey area. In this example, survey system 20 is a marine system comprising a marine seismic survey vessel or tow vessel 22 designed to tow one or more multi-component streamers 24. Each multi-component streamer 24 comprises multiple sensors 26 arranged in a desired distributed sensor network 27. The sensors 26 are designed to collect data related to the subterranean formations located below the streamers 24 throughout the survey area. According to one embodiment, multiple sensors 26 are designed to collect both gravity data and seismic data. The sensors 26 each comprise one or more accelerometers 28 connected at each sensor location along the streamer 24 to collect both the seismic accelerations and the gravity data. However, other types of sensors, e.g. pressure sensors 30 and/or additional parameter sensors, may be connected along streamers 24 to collect other types of useful data related to the survey.

In the example illustrated, the survey system 20 also comprises one or more seismic sources 32 which are towed by tow vessel 22. The seismic source or sources 32 may comprise air guns, marine vibrators, or other types of sources which are actuated, e.g. fired, to create a seismic signal. The tow vessel 22 carries out a seismic survey by firing the seismic source or sources 32 and by detecting reflected signals via sensors 26. The seismic data obtained by sensors 26 are relayed along the corresponding streamer 24 to a processing system 34 located on, for example, the tow vessel 22. However, processing system 34 may be located in whole or in part at other locations. In the present embodiment, the sensors 26 also are designed to collect gravity data which are similarly relayed to processing system 34 for storage and processing. The gravity data may be obtained, relayed, stored and processed without requiring any substantial change to the hardware of the streamers 24 or tow vessel 22. By way of example, processing system 34 may be a computer-based processing system utilizing one or more microprocessors to evaluate collected data. The processing system 34 also may be used to independently store gravity data and seismic data.

The gravity data are useful in evaluating the potential for hydrocarbons in subterranean environments. Differences in gravity measurements may be indicative of geological structures including those which may be reservoirs of hydrocarbons. The earth's gravity is the magnitude of the acceleration experienced by a proof mass at a defined location. The gravitational vector, g, has three components, of which the vertical is so dominant that g is conventionally used to define the vertical direction. It is measured by the zero frequency, or DC signal, from an accelerometer orientated parallel to g, henceforth assumed to be vertical. Although conventional accelerometers might struggle to accurately measure the DC component, this is now possible with modern, broad-band micro-electromechanical system (MEMS) accelerometers. It is known that the seismic streamer 24 may slowly rotate during the survey, but this rotation may be compensated as discussed in greater detail below.

In one embodiment, each streamer 24 employs sensors 26 at multiple sensor locations and each sensor 26 uses the DC acceleration from three mutually orthogonal seismic accelerometers 28, mounted along and perpendicular to the streamer axis, to define the vertical direction. Hence, computation is enabled of the streamer angular displacement in two orthogonal, vertical planes and the components of the seismic response in the axial, vertical and transverse directions. Sensor orientation in the horizontal plane is provided by the in-sea and vessel positioning systems. As illustrated in FIG. 2, for example, each multi-component accelerometer sensor 26 may comprise a trio of accelerometers 28 mounted inside the streamer 24 at each sensor location. In this embodiment, the accelerometers 28 of a given sensor 26 are mounted parallel and perpendicular to an axis 36 of the streamer 24 and orthogonal with respect to each other, as illustrated. Alternatively, two mutually orthogonal accelerometers may be oriented through a gimbal system in a vertical plane containing the local streamer axis 36, as illustrated in FIG. 3. In this alternate embodiment, each accelerometer sensor 26 comprises a first accelerometer 28 mounted to a gimbal mechanism 38 with an orientation perpendicular to the streamer axis 36 and a second accelerometer 28 mounted parallel to the streamer axis 36. The sensors 26 also may you deployed in land based or seabed based systems, as discussed in greater detail below.

The earth's gravitational field varies with position, partly due to changes in latitude and elevation (which can be accounted for in principle) and partly as a result of changes in the density of sub-surface geological formations. The sensors 26 are designed to detect these changes and produce corresponding output signals. The latter signal which is representative of changes in the density of sub-surface geological formations can be used to assist seismic processing (e.g., helping to constrain velocity models for imaging and for interpreting large scale geological features). While absolute gravitational measurements are desirable, these are difficult to obtain and require accurate calibration against a base station before and after a survey. Relative changes in gravity with position, however, are still useful in characterizing gravitational anomalies from the sub-surface and are of benefit in imaging and in interpretation, provided the drift in the accelerometer is small. If the drift is not small but is linear with time, then calibration may be achieved by returning to a known location at intervals, albeit at a possible cost to the survey.

According to one embodiment of survey system 20, each streamer 24 contains a large number of densely spaced sensors 26 in the form of accelerometers 28 which record data with a bandwidth from 0 Hz to Nyquist (250 Hz is a typical frequency for a seismic survey). While the seismic tow vessel 22 is conducting a seismic survey, accelerometer data from sensors 26 are relayed to the processing system 34, e.g. a computer-based processing system located on tow vessel 22. It is possible to store all the data over the full bandwidth, however some embodiments of the present technique create a new data-set containing the low frequency part of the accelerometer data used in determining the gravity measurements. For this purpose the accelerometer data are filtered down to a relatively low frequency, e.g. well below 1 Hz, and stored with a sample period less than or equal to 0.5 s. The gravity data are continuously acquired and stored independently of the seismic shots fired by the tow vessel 22 via seismic sources 32. As this low frequency gravity dataset is being processed and stored on processing system 34, a separate data stream containing the seismic data is processed and stored. The seismic data are based on the relatively higher frequency data obtained from sensors 26/accelerometers 28.

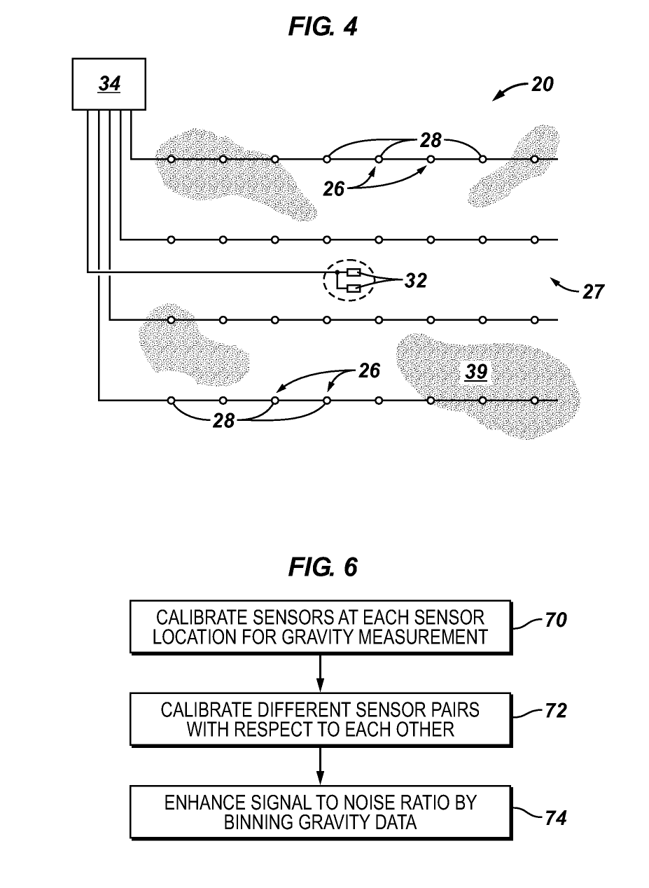

In FIG. 4, an alternate embodiment of survey system 20 is illustrated in which the sensors 26 are arranged in a desired sensor distribution network 27 along a solid surface 39. By way of example, the solid surface 39 may comprise a land surface, e.g. when survey system 20 comprises a land based seismic/gravity acquisition system, or a seabed, e.g. when survey system 20 comprises a subsea seismic/gravity acquisition system. In these embodiments, the sensors 26 may again comprise accelerometers 28 as described above. The one or more sources 32 may be located at a suitable location along or in solid surface 39, e.g. along or in a land surface or seabed. In some applications, the one or more sources 32 may be located in or adjacent a wellbore. By way of further example, the sensor distribution network 27 and the associated sensors 26 may be constructed as a permanently installed monitoring system.

Similar to the marine embodiment described with reference to FIG. 1, both the sources 32 and the sensors 26 are communicatively coupled with processor system 34. Depending on the design of sensor distribution system 27, the sensors 26 and/or sources 32 may be coupled with processor system 34 via wired or wireless communication systems. As with the marine-based system, the sensors 26 are designed to obtain and monitor both seismic data and gravity data. The number of sensors and the arrangements of sensors within the sensor distribution network 27 can vary substantially from one application to another. For example, a seabed based acquisition system 20 may vary in design and size relative to a surface land acquisition system 20.

From the above, it is evident that stationary sensors, as mounted in a land seismic system or on the seabed, present several simplifications of the gravity measurements, including removal of dynamic components due to smooth or uneven motion of the platform. Calibration and sensor drift may require the adoption of test procedures, such as comparison of the sensors with an accurate, portable gravimeter, which can increase field cost. However, as in the case of 4D seabed gravimetry with portable gravimeters, recalibration cost may be a worthwhile cost in certain applications.

As described herein, the gravity measurements may be obtained from a spatially distributed network 27 comprising many multi-component sensors 26, e.g. accelerometers 28. In some applications, the gravity measurements are obtained from data acquired by accelerometers 28 mounted in a seismic streamer 24. In these marine applications, horizontal gradients of gravity also may be obtained from the data acquired by accelerometers 28 mounted in the seismic streamer before.

However, gravity measurements also may be obtained from data acquired by sensors 26, e.g. accelerometers, mounted in a land seismic system utilizing the sensor distribution network 27. As in marine applications, horizontal gradients of gravity may be obtained from data acquired by accelerometers 28, or other sensors 26, mounted in the land seismic system. Similarly, gravity measurements may be obtained from data acquired by sensors 26, e.g. accelerometers 28, permanently mounted in a seabed seismic system. Horizontal gradients of gravity also may be obtained from data acquired by the sensors 26 permanently mounted in the seabed seismic system.

In many of these sensor distribution network embodiments, gravity measurements may be obtained from a low frequency (e.g. less than 1 Hz) data set while the high-frequency data sent from the same accelerometers may be used for seismic measurements. Gravity measurements may be obtained through filtering, binning, and averaging the data acquired, as discussed in greater detail below. Similarly, a horizontal gravity measurement may be obtained through filtering, binning, and averaging the data acquired from the sensors 26 in the distributed sensor network 27. The densely sampled gravity and/or gravity gradient data acquired from spatially distributed sensor networks 27 may be processed using suitable algorithms, such as a potential field migration algorithm.

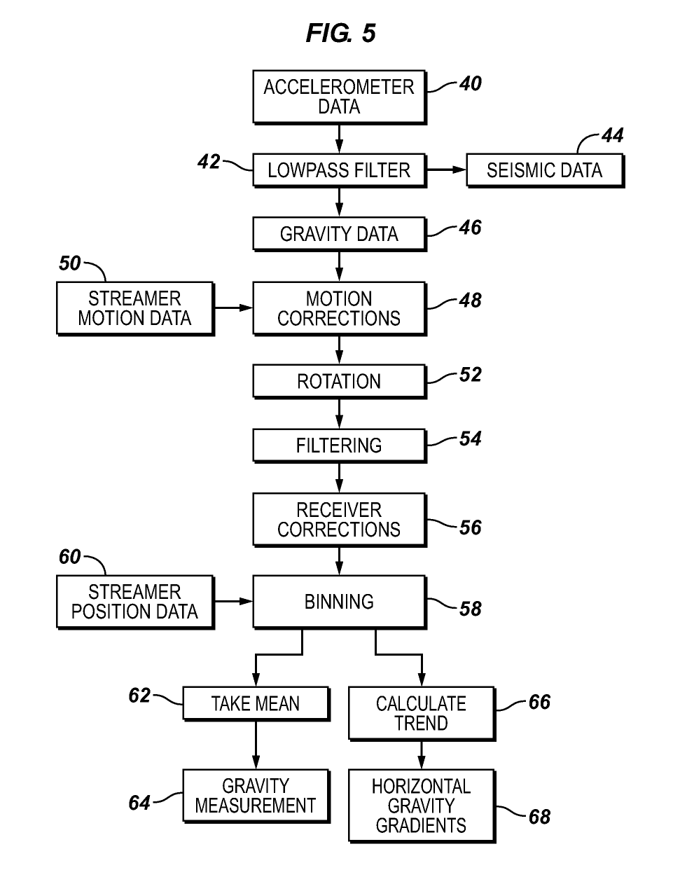

Referring generally to FIG. 5, a flowchart is provided as an example of one approach for obtaining, processing, and outputting gravity information and/or seismic information in, for example, a marine based system or a land based system. As illustrated, accelerometer data are collected via the multiple sensors 26, e.g. accelerometers 28, positioned throughout distributed sensor network 27, as represented by block 40. In marine-based systems, the sensors 26 are positioned along the streamers 24. Regardless of the specific environment, the accelerometer data may be delivered to a low pass filter 42 of processing system 34 which separates the data into the relatively high-frequency seismic data (see block 44) and the relatively low frequency gravity data (see block 46). The gravity data may be acquired and stored independently of shots fired by seismic sources 32; and the gravity data and seismic data also may be independently processed and stored via processing system 34.

The seismic data 44 are processed according to various customary procedures, and the gravity data 46 may be corrected for environmental parameters. If seismic system 20 is used in a marine environment, for example, the gravity data may be processed by a motion correction module 48 of processing system 34 based on streamer motion data, as represented by block 50. The motion corrections may comprise correction for sensor rotation, as indicated by block 52. However, other types of motion corrections, or no motion corrections, may be needed in land based applications or other seismic applications in which the sensors are not subjected to these external wave motion inputs.

Regardless of the application and environment, the data may be filtered to improve the signal to noise ratio, as indicated by block 54. The processing system 34 also may utilize a receiver correction module 56 to process the gravity data in a manner designed to provide receiver corrections. For example, the gravity data may be subjected to a binning process, as represented by block 58. In marine surface applications, the binning process may be based on streamer position data, as represented by block 60.

Once the various corrections have been performed, averaging techniques may be employed, e.g. taking mean averages, as represented by block 62. The averaging facilitates determination of desired gravity measurements, as indicated by block 64. The corrected gravity data also may be used to calculate trends, as represented by block 66, which enables calculation of horizontal gravity gradients, as represented by block 68. The gravity measurements and/or seismic measurements may be output to a display device of processing system 34, or otherwise output, to provide an operator with desired information on the subterranean formation.

Depending on the parameters of a given survey area, the specific survey equipment, and the survey techniques employed, various corrections may be applied to the raw gravity data collected by sensors 26. Examples of such corrections are described above with reference to FIG. 5. However, specific types of corrections and other processing of the data may be adjusted according to the specific areas, equipment and techniques. Examples of specific processing/adjustments of the gravity data include tidal corrections based on the position of the sun and the moon and a Bouguer correction for the average streamer depth. A further correction for the shape of sea-surface may be applied. Reliable wave height data can be obtained from low frequency pressure data via available methods, such as the method described by Laws, R. and E. Kragh, 2006, Sea Surface Shape Derivation above the Seismic Streamer, Geophysical Prospecting 54, No. 6 (2006): 817-828. Eötvös corrections may be applied to compensate for the directional movement of the sensors 26. For example, this correction can utilize the available, accurate streamer positioning system of the seismic tow vessel 22 to calculate sensor position, speed, acceleration and direction.

Subsequently, various receiver corrections may be applied. For example, temperature corrections, e.g. seawater temperature corrections, may be applied to the accelerometer readings. Next, the gravitational acceleration may be calculated by taking the squared sum of the three orthogonal acceleration measurements, at least when sensors 26 comprise orthogonal accelerometers 28, as illustrated in FIG. 2. For quality control, the inline component may be obtained and monitored through mathematical operations such as projection and rotation, enabling correction of streamer axial tilt or sag. Such numerical operations also may be required even when gimbaled accelerometers are used, as illustrated in FIG. 3, as streamer sag may tilt the gimbaled component off vertical. In addition to correcting for cable sag, the axial acceleration component (accelerometer) may also be useful for estimating changes in axial velocity due to tugging, affecting the Eötvös correction.

In certain marine applications, noise reduction may be carried out based on the principle that a large number of sensors 26 in the streamer 24 will pass over the same location during the survey. When analyzing the dataset in the temporal and spatial dimensions it is clear that a gravity signal will move through the dataset with the streamer's speed while many other signals and perturbations, such as the effect of wave heights and streamer shapes, will move with different speed. A filter may be applied that enhances those signals which propagate with the streamer speed, attenuating signals with other velocities (see filter block 54 in FIG. 4).

In many applications, calibration of the accelerometers can be very helpful in obtaining the desired gravity measurements, as illustrated by blocks 56, 58, 60 of FIG. 5. Specific examples of calibration are further illustrated in the flowchart of FIG. 6 and are described in greater detail as follows. Initially the orthogonal accelerometers 28 of individual sensors 26 may be calibrated at each sensor location within the sensor distribution network 27 to enable better measurement of gravity data, as represented by block 70. The calibration may be performed according to a variety of techniques. For example, the calibration can be achieved in certain marine applications by an enforced streamer axial rotation, e.g. using controlled birds, which allows the DC components from the three orthogonal accelerometers to be calibrated relative to each other (see, for example, the description by Nicolas Goujon, Ahmet Kemal Ozdemir and Bent Kjellesvig in International Application Number PCT/US2008/074230 “Calibrating an Accelerometer on a Seismic Cable”) and to the nominal gravitational acceleration, based on prior knowledge for a standard location (as for a gravitational base station). Axial rotation primarily calibrates the sensors spanning the plane perpendicular to the streamer axis while rotation about the cable drum (for example during streamer deployment or retrieval) may serve primarily to calibrate the axial sensor.

A subsequent calibration may comprise calibrating the different sensor pairs with respect to each other, as represented by block 72 of FIG. 6. In certain marine applications, different sensor pairs in each streamer may be subsequently calibrated. Here, data are selected during the survey from arbitrary rotated sensors that follow a certain path along the surface, i.e. all sensor measurements are taken at the same large number of positions. Subsequently, for each sensor, the root mean square (RMS) energy is calculated over the entire surface path. As all the selected sensors 26 have passed over the same subsurface gravity anomalies their RMS energy should be the same. Any variation is due to calibration, noise and drift errors. To reduce these errors, a sensor calibration coefficient is calculated. This could be achieved by, for example, dividing the RMS energy for each sensor 26 by the RMS average over all sensors. The gravity measurements for each sensor 26 may then be divided by their calibration coefficient.

To further enhance the signal to noise ratio of the gravity data, the measurements from nearby sensors 26 are summed according to a binning procedure, as represented by block 74. According to this procedure, a surface grid is initially determined. The grid or bin size may be between, for example, 100-500 m square. Using the positioning data, the time period over which a particular sensor 26 was in a particular bin is determined. The sensor's gravity data for this particular time window is then allocated to this bin. Based on this process, each bin may eventually contain a large number of sensor measurements, e.g. more than 10,000 sensor measurements, taken from locations throughout the sensor distribution network 27. In land based applications, the sensor measurements may be taken from numerous locations throughout the distribution network. In marine surface applications, multiple sensor measurements may be taken from neighboring streamers towed at separations of, for example, 25 m and more. In addition, data from different sail lines can be included in the bins.

A gravity measurement may be obtained by calculating the mean measurement in each bin. Alternatively, other statistical measures may be employed, such as calculating the median values. Outliers in the data-set may be removed prior to calculation of the mean. The average binned gravity measurement is one deliverable of the present method. Use of ensemble averaging of data from the large number of sensors 26 facilitates achieving the desired, enhanced precision with respect to gravity measurements and contrasts with the temporal averaging from a single high-precision sensor in conventional gravimetry.

The horizontal gradients of the gravity field also can be obtained from the binned dataset. To do so, one calculates the linear trend in two horizontal orthogonal directions of the measurements in a bin. The calculations may be performed on processing system 34, although it may be desirable to first remove some outliers in the data set. It also may be desirable to calculate these horizontal gradients using larger bins than used for the gravity measurement itself.

The survey system 20 may be used for exploration surveys and also for repeated surveys to detect, for example, the movement of the contact between hydrocarbons and water in the subsurface. While it is anticipated that a higher level of sensor precision may be needed to detect production-induced density changes in the sub-surface compared to the precision needed for exploration imaging and interpretation, these 4D gravity surveys may be optimized by carrying them out at an appropriate time interval, months or years apart, to maximise the expected signal. The 4D gravity measurements also may require a different positioning precision as compared to 4D seismic data.

The embodiments discussed above provide examples of systems, components and methodologies that may be used to improve the results of surveys by obtaining gravity data through the use of distributed sensor networks and by taking ensemble averages of very large numbers of relatively low-precision sensors in contrast to temporal averaging of a small number (typically one) of high-precision sensors. Such distributed measurements may provide high-density spatial sampling of the gravity field, enabling the computation of gradients and facilitating the application of processing techniques such as potential field migration. Depending on the specific application and environment, the arrangement of systems and components may be changed or adjusted to accommodate the characteristics of the application and environment. In an alternate embodiment, for example, the streamers may be towed at a depth to greatly reduce vertical accelerations due to wave motion, which may remove or reduce the need to filter the gravity response. In other embodiments, the sensors may be positioned in a variety of patterns along a land surface, along a seabed, or at a variety of permanent installation locations. Additionally, the number of sensors, sources and other components may be adjusted according to the specific parameters of a given application. Individual or multiple control systems 34 may be employed with a variety of algorithms and data processing techniques to correct, calibrate and/or adjust the raw gravity data to provide useful gravity measurements. The processing of gravity data and seismic data may be performed on the same processing system 34 or on separate, individual processing systems. Additionally, the processing may be performed with computer-based systems, such as microprocessor based computers, deployed at the survey site and/or at other remote locations.

Although only a few embodiments of the present invention have been described in detail above, those of ordinary skill in the art will readily appreciate that many modifications are possible without materially departing from the teachings of this invention. Accordingly, such modifications are intended to be included within the scope of this invention as defined in the claims.

What is claimed is:

1. A method of obtaining gravity measurements in a seismic application, comprising:
forming a distributed sensor network with a plurality of sensors;
arranging the plurality of sensors in a desired pattern; and
accumulating gravity data with the plurality of sensors.

2. The method as recited in claim 1, wherein arranging comprises deploying multiple multi-component accelerometers throughout the distributed sensor network along a land surface, and wherein accumulating comprises accumulating horizontal gradients of gravity from data acquired by the multiple multi-component accelerometers.

3. The method as recited in claim 1, wherein arranging comprises deploying multiple multi-component accelerometers throughout the distributed sensor network along a seabed, and wherein accumulating comprises accumulating horizontal gradients of gravity from data acquired by the multiple multi-component accelerometers.

4. The method as recited in claim 1, further comprising conducting a seismic survey while accumulating gravity data.

5. The method as recited in claim 4, wherein conducting the seismic survey comprises collecting seismic data with the plurality of sensors.

6. The method as recited in claim 1, further comprising processing densely-sampled gravity and/or gravity gradient data acquired from the distributed sensor network using a potential field migration algorithm.

7. The method as recited in claim 4, wherein accumulating comprises accumulating gravity data from a low frequency dataset while seismic measurements are obtained from a higher frequency dataset collected from the same plurality of sensors.

8. The method as recited in claim 1, further comprising filtering, binning, and averaging the gravity data.

9. The method as recited in claim 1, further comprising employing ensemble averaging of data from the plurality of sensors to achieve desired precision measurements.

10. A method of conducting a seismic survey, comprising:
arranging a distributed network comprising multiple accelerometers;
collecting seismic data from the multiple accelerometers; and
simultaneously collecting gravity data from the multiple accelerometers.

11. The method as recited in claim 10, wherein arranging comprises arranging the distributed network comprising multiple accelerometers temporarily or permanently mounted along a surface land environment.

12. The method as recited in claim 10, wherein arranging comprises arranging the distributed network comprising multiple accelerometers temporarily or permanently mounted along a seabed.

13. The method as recited in claim 10, further comprising correcting the gravity data to compensate for environmental parameters.

14. The method as recited in claim 10, further comprising calibrating the accelerometers at each sensor location by calibrating orthogonal accelerometers.

15. The method as recited in claim 10, further comprising calibrating the accelerometers by calibrating accelerometers, located at different sensor locations, with respect to each other.

16. The method as recited in claim 10, further comprising reducing the signal to noise ratio of the gravity data by binning the gravity data.

17. The method as recited in claim 10, wherein simultaneously collecting further comprises collecting and processing horizontal gravity measurement data.

18. A system, comprising:
a survey system having a distributed sensor network comprising a plurality of sensors, the survey system further comprising a processing system to process data transferred from the plurality of sensors, wherein the processing system processes the data in a manner which provides both seismic information and gravity measurements.

19. The system as recited in claim 18, wherein the plurality of sensors comprises a plurality of accelerometers.

20. The system as recited in claim 19, wherein the processing system employs ensemble averaging of data from the plurality of sensors to achieve desired precision measurements.
